(19) United States
(12) Patent Application Publication
(10) Pub. No.: US 2004/0100799 A1
(43) Pub. Date: May 27, 2004

(54) Umbrella shape table lamp

(76) Inventors: Ching Tien Chu, Taichung (TW); Hsin Yong Lu, Taichung (TW)

Correspondence Address: Ching Tien Chu, 235 Chung-Ho, Box 8-24, Taipei, TW

(21) Appl. No.: 10/300,960

(22) Filed: Nov. 22, 2002

(51) Int. Cl. F21V 1/06; F21L 4/02; F21S 8/08

(52) U.S. Cl. 362/352; 362/414; 362/248; 362/184

(57) ABSTRACT

An umbrella shape table lamp has a metal tube; an upper end of the metal tube and a plurality of bones. An upper end of the metal tube is installed with a lighting device at a middle position of the umbrella shape lampshade. The lighting device includes two lamp seats. Each of the lamp seats is formed by an upper half lamp seats and a lower half lamp seat. A positioning seat serves to connect the two lamp seats. Each lamp seat has a lampshade body which is divided into two parts. Each lamp seat has a bulb assembling cover for assembling a light reflecting cover, a bulb and an auxiliary conductive piece. Thus the umbrella shape table lamp has a beautiful outlook and has two bulbs so that the illumination coverage is wider that those of prior art.

### FIELD OF THE INVENTION

The present invention relates to table lamps, and particularly to an umbrella shape table lamp.

There are various types of table lamps. However, there are no table lamps having an umbrella shape. This is because the bones of the umbrella will confine the structure of the table lamps. Thereby, there is an eager demand for a novel design of table lamps which has a shape like an umbrella so as to present a beautiful outlook to the users.

### SUMMARY OF THE INVENTION

Accordingly, the primary object of the present invention is to provide an umbrella shape table lamp which has a beautiful outlook like an umbrella shape lampshade, but occupies a small space so that users feel pleasure.

Another object of the present invention is to provide an umbrella shape table lamp which has two bulbs so that the illumination coverage is wider that those of prior art.

The various objects and advantages of the present invention will be more readily understood from the following detailed description when read in conjunction with the appended drawing.

### BRIEF DESCRIPTION OF THE DRAWINGS

FIG. 1 is a perspective view and (a) is a partial enlarger view of the present invention.

FIG. 2 is an exploded perspective view of the lighting device of the present invention; and

FIG. 3 is a front view (A) and lateral view (B) of the present invention.

### DETAILED DESCRIPTION OF THE PREFERRED EMBODIMENTS

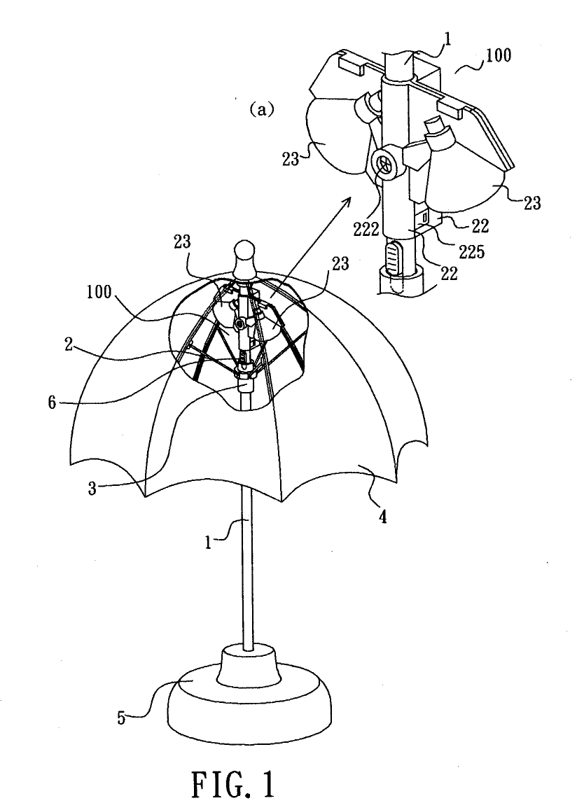

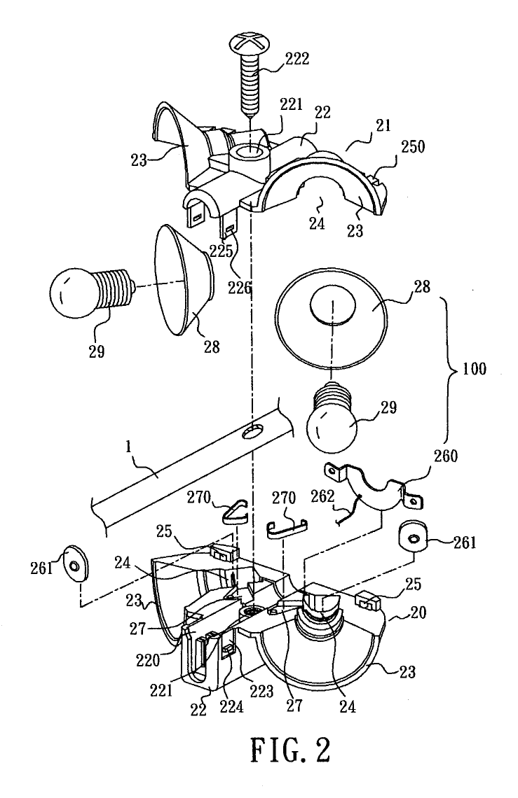

With reference to FIGS. 1, 2 and 3, the umbrella shape table lamp of the present invention is illustrated. The umbrella shape table lamp has a metal tube 1. An upper end of the metal tube 1 is assembled with an umbrella shape lampshade 4. A plurality of bones 2 are connected between the umbrella shape lampshade 4 and the metal tube 1. Each bone 2 is connected to a sleeve 3 for controlling the opening and closing of the umbrella shape lampshade 4. An upper end of the metal tube 1 is installed with a lighting device 100 at a middle position of the umbrella shape lampshade 4.

The lighting device 100 is formed by two lamp seats. Each of the lamp seats is formed by an upper half lamp seats 20 and a lower half lamp seat 21. A positioning seat 22 serves to connect the two lamp seats. The positioning seat 22 is formed by two parts, the upper part servers to connect the two upper half lamp seats 20 and the lower part serves to connect the two lower half lamp seat 21. The upper part has an assembled groove 220 and the lower part has a screw hole 221. Thereby, the upper part and the lower part are assembled by a screw to passing through the assembled groove 220 and the screw hole 221. Then, the lighting device 100 can be locked to the metal tube 1 by using a screw rod 222.

Moreover, one end of each lower half lamp seat has an embedded groove 25 and one respective end of each upper half lamp seat has an embedding block 225 which is embedded into the embedded groove 25. Another end of the upper half lamp seat 20 has a buckle 225 and the buckle 225 has an upper buckled groove 226. The lower half lamp seat 21 has a lower buckled groove 223 and a buckling block 224. Thereby, the upper and lower half lamp seats 20, 21 are assembled by assembling the buckle 225, upper buckled groove 226, lower buckled groove 223 and buckling block 224.

Each lamp seat has a lampshade body 23 which is divided into two parts. One is in the upper half lamp seat 20 and the other is in the lower half lamp seat 21. Each lamp seat has a bulb assembling cover 24 for assembling a light reflecting cover 28, a bulb 29 and an auxiliary conductive piece 261.

The two assembling covers 24 have respective embedding slots 26 which are communicated with one another. Each embedding slot 26 has a positive conductive piece 260. The two terminals of the positive conductive piece 260 resist against an auxiliary conductive piece 261. Then the positive conductive piece 260 contacts the auxiliary conductive piece 261. The positive conductive piece 260 is not in contact with the metal tube 1. The positive conductive piece 260 is connected to a positive power wire 262.

The two bulb assembling grooves 24 are connected by a positioning groove 27. A negative conductive piece 270 is assembled to the bulb positioning groove 27. One end of the negative conductive piece 270 resists against a periphery of the bulb 29 and another end thereof resists against the metal tube 1.

The lighting device 100 has a table seat 5 for receiving a battery. The lighting device 100 has a power switch 6. A positive power wire 262 of the battery is connected to the power switch 6 and then is connected to the positive conductive piece 260. The negative power wire of the battery is connected to the metal tube 1 and then to the negative conductive piece 270.

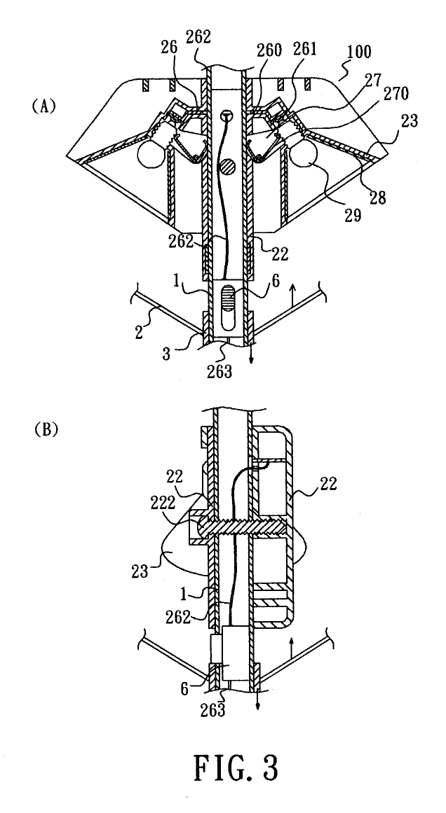

The advantages of the present invention will be described here. The two lampshades 23 will not interfere the operation of the bones 2. Referring to FIGS. 1 and 3A, when the sliding sleeve 3 moves upwards, the power switch 6 will cause the power to be conductive and to expand the bones 2. The umbrella shape lampshade 4 is opened and thus the lighting device 100 lights up.

Namely, the power switch 6 is conductive. Power is transferred to the positive conductive piece 260 through the positive power wire 262 and then through the auxiliary conductive piece 261 to conduct the bulb 29. The negative conductive piece 270 is in contact with the bulb 29 and then is in contact with the metal tube 1. The negative electrode of the battery contacts the metal tube 1. Thereby, a conductive loop is formed by above elements. When it is desired to extinguish the bulb, it is only necessary to move the sliding sleeve 3 downwards so that the power switch 6 is closed. Moreover, the bones 2 are pulled to approach the metal tube 1 so as to close the umbrella shape lampshade 4.

The effects of the present invention is:

(1) The lampshades 23 face downwards so that the light emits downwards.

(2) The two lamp seats 20, 21 are formed by two half lamp seats so that they can firmly secure to the metal tube 1.

(3) The positive conductive piece 260 is connected to the two bulbs so that the two bulbs can be conductive at the same time.

(4) The negative conductive piece 270 contacts the metal tube 1, bulb and metal tube 1, and then contacts with a negative power source so as to form a conductive path, and thus the one power wire can be saved. Only one positive conductive piece 260 is necessary.

(5) The outlook of the umbrella shape table lamp will make the user feel pleasure.

Furthermore, the negative power source of the present invention can be directly connected to the negative conductive piece 270 without passing through the metal tube 1.

Moreover, other than batteries, other power source can be used as the power source of the present invention. For example home used AC current through a conductive wire can be connected to the umbrella shape table lamp of the present invention.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An umbrella shape table lamp having a metal tube; an upper end of the metal tube being assembled with an umbrella shape lampshade; a plurality of bones being connected between the umbrella shape lampshade and the metal tube; each bone being connected to a sleeve for controlling the opening and closing of the umbrella shape lampshade; an upper end of the metal tube being installed with a lighting device at a middle position of the umbrella shape lampshade; characterized in that:
the lighting device includes two lamp seats; each of the lamp seats is formed by an upper half lamp seats and a lower half lamp seat; a positioning seat serves to connect the two lamp seats; the positioning seat is formed by two parts, the upper part servers to connect the two upper half lamp seats and the lower part serves to connect the two lower half lamp seat; the upper part has an assembled groove and the lower part has a screw hole; thereby, the upper part and the lower part are assembled by a screw to pass through the assembled groove and the screw hole; then, the lighting device is locked to the metal tube by using a screw rod;
one end of each lower half lamp seat has an embedded groove and one respective end of each upper half lamp seat has an embedding block which is embedded into the embedded groove; another end of the upper half lamp seat has a buckle and the buckle has an upper buckled groove; the lower half lamp seat has a lower buckled groove and a buckling block; thereby, the upper and lower half lamp seats are assembled by assembling the buckle, upper buckled groove, lower buckled groove and buckling block;
each lamp seat has a lampshade body which is divided into two parts; one is in the upper half lamp seat and the other is in the lower half lamp seat; each lamp seat has a bulb assembling cover for assembling a light reflecting cover, a bulb and an auxiliary conductive piece;
the two assembling covers have respective embedding slots which are communicated with one another; each embedding slot has a positive conductive piece; the two terminals of the positive conductive piece resist against an auxiliary conductive piece; then the positive conductive piece contacts the auxiliary conductive piece; the positive conductive piece is not in contact with the metal tube; the positive conductive piece is connected to a positive power wire;
the two bulb assembling grooves are connected by a positioning groove; a negative conductive piece is assembled to the bulb positioning groove; one end of the negative conductive piece resists against a periphery of the bulb and another end thereof resists against the metal tube; and
the lighting device has a table seat for receiving a battery; the lighting device has a power switch; a positive power wire of the battery is connected to the power switch and then is connected to the positive conductive piece; the negative power wire of the battery is connected to the metal tube and then to the negative conductive piece.
